(19) United States
(12) Patent Application Publication
(10) Pub. No.: US 2010/0176994 A1
(43) Pub. Date: Jul. 15, 2010

(54) ANTENNA HOLDER FRAME ASSEMBLY FOR NOTEBOOK COMPUTER

(76) Inventor: Chih-Wei CHANG, Pa-Te City (TW)

Correspondence Address: Guice Patents PLLC, 12647 Galveston Court #302, Manassas, VA, 20112, US

(21) Appl. No.: 12/352,646

(22) Filed: Jan. 13, 2009

(51) Int. Cl. H01Q 1/24

(52) U.S. Cl. 343/702

(57) ABSTRACT

An antenna holder frame assembly includes a narrow elongated holder frame mounted on the top side of a display screen of a notebook computer, a plurality of circuit boards fixedly mounted in the holder frame, each circuit board providing a ground plane and having a signal bus line electrically connected to a motherboard in the notebook computer, and a plurality of strip antennas of different operating bands embedded in the front edge of the holder frame and electrically connected with the respective feed-in terminal to the circuit boards for allowing the receiving signal to transmitted to the motherboard through one associating circuit board.

### BACKGROUND OF THE INVENTION

1. Field of the Invention

The present invention relates to antenna mounting technology for notebook computer and more particularly, to an antenna holder frame assembly that has strip antennas of different operating bands embedded in a holder frame at the top side of the display screen of a notebook computer.

2. Description of the Related Art

Following fast development of wireless communication technology, many different wireless communication standards, such as Global Positioning System (GPS), Global System for Mobile Communications (GSW), Digital Communication System (DCS), Integration of Mobile and Fixed Network (IMT-2000 (3G)), Bluetooth, Ultra Wideband Communication (UWB), and etc., are developed for services in different operating bands.

Because different wireless communication standards use different bands, different antennas may be used in different mobile communication devices to fit different operating bands. Further, following fast development of notebook technology, advanced notebook computers have different mobile communication devices built therein. To match with different mobile communication devices of different wireless communication standards in a notebook computer, different antennas should be installed in the casing of the notebook computer. In order to save installation space, low-profile planar antennas are commonly used for notebook computer.

According to conventional antenna mounting techniques for notebook computer, low-profile planar antennas are made from metal strips and then respectively affixed to the inside of the casing of the notebook computer, for example, the shell of the display screen, by screws. When a big number of antennas are used for different operating bands, the installation of the planar antennas will require much time and labor. Further, using a big number of screws to affix a big number of planar antennas to the casing of a notebook computer relatively increase the thickness and weight of the notebook computer, not in favor of a compact design. Therefore, an improvement in this regard is necessary.

### SUMMARY OF THE INVENTION

The present invention has been accomplished under the circumstances in view. It is therefore the main object of the present invention to provide an antenna holder frame assembly for notebook computer, which facilitates quick installation of different strip antennas for different operating bands, saving installation space and meeting low profile requirements.

To achieve this and other objects of the present invention, the antenna holder frame assembly comprises a holder frame bonded to the top side of the display screen of a notebook computer, a plurality of strip antennas embedded in the holder frame and operative in different bands, a plurality of circuit boards mounted inside the holder frame and respectively electrically connected with the feed-in terminals of the strip antennas for transmitting signals from the strip antennas to the motherboard of the notebook computer through a respective bus line.

### BRIEF DESCRIPTION OF THE DRAWINGS

FIG. 1 is a schematic drawing showing an antenna holder frame assembly installed in a notebook computer in accordance with the present invention.

FIG. 2 is an exploded view of the antenna holder frame assembly in accordance with the present invention.

FIG. 3 is an enlarged view of a part of FIG. 2.

FIG. 4 is a perspective assembly view of a part of the antenna holder frame assembly in accordance with the present invention.

FIG. 4A is an enlarged view of part A of FIG. 4.

### DETAILED DESCRIPTION OF THE PREFERRED EMBODIMENT

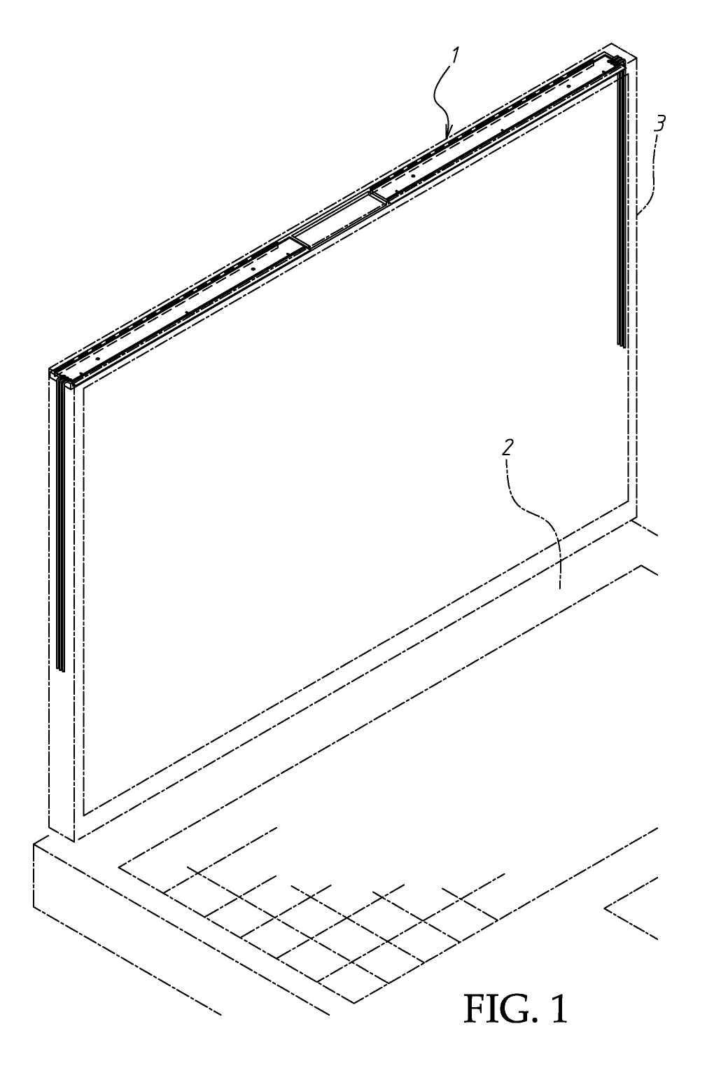

Referring to FIG. 1, an antenna holder frame assembly 1 is shown mounted on the top side of the display screen 3 of a notebook computer 2.

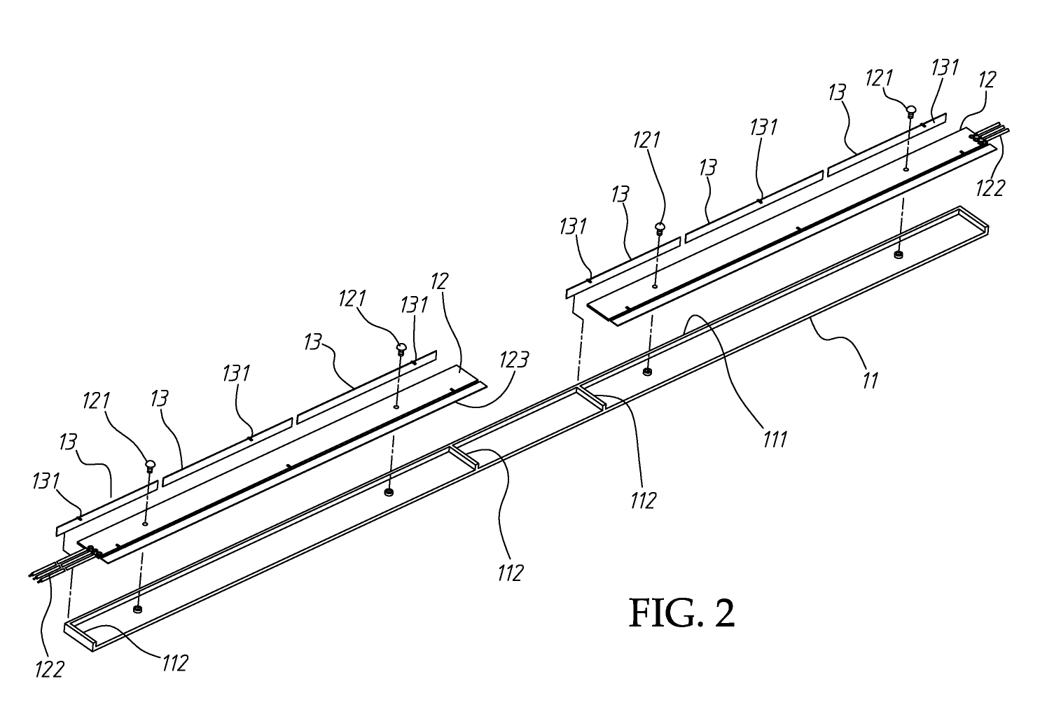

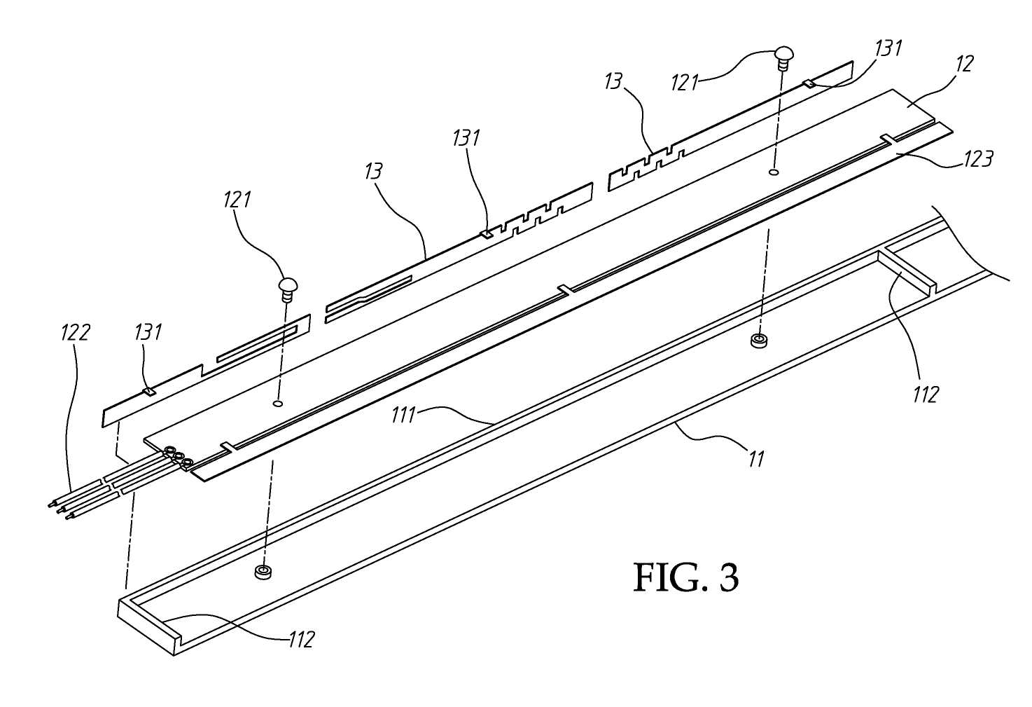

Referring to FIGS. 2˜4, the antenna holder frame assembly 1 is comprised of a holder frame 11, a plurality of circuit boards 12, and a plurality of strip antennas 13.

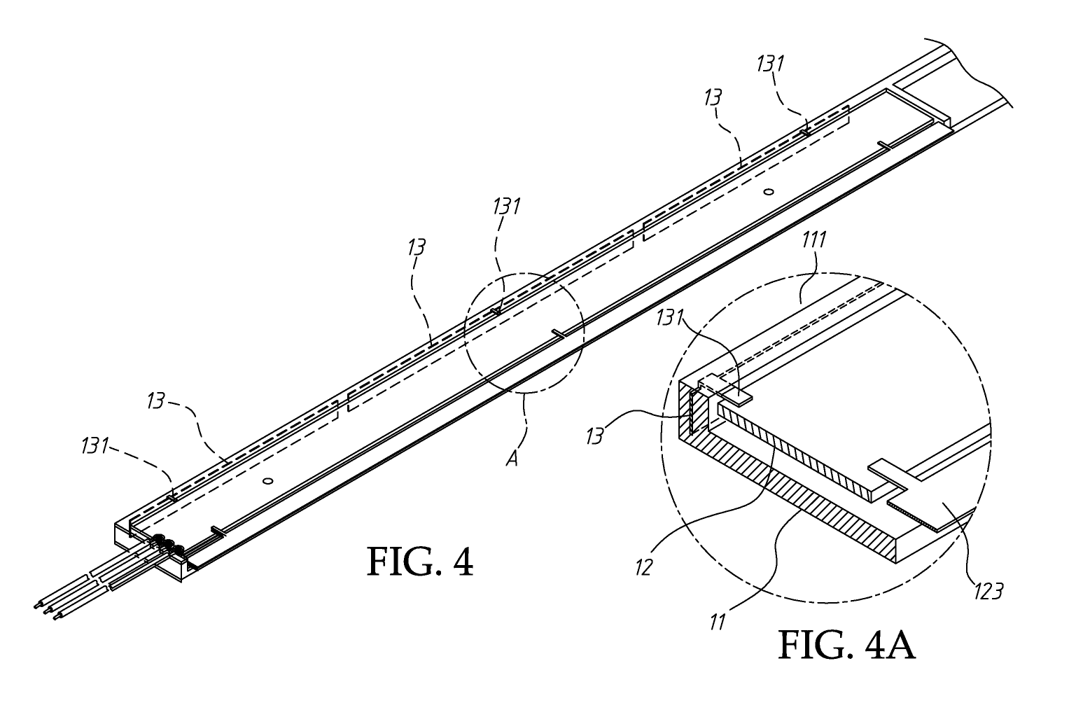

The holder frame 11 is a narrow elongated frame member fitting the top edge of the display screen 3, having a front edge 111 and a plurality of transverse partition ribs 112 that divide the holder frame 11 into multiple accommodation spaces for accommodating the circuit boards 12. The circuit boards 12 are respectively mounted in the accommodation spaces in the holder frame 11 and affixed thereto with screws 121, each having a signal bus line 122 respectively electrically connected to a motherboard (not shown) in the notebook computer 2. Further, each circuit board 12 has a ground plane 123. The strip antennas 13 are embedded in the front edge 111 of the holder frame 11. According to the present preferred embodiment, the number of the strip antennas 13 is 6. The strip antennas 13 have a respective operating band, and a respective feed-in terminal 131 respectively electrically connected to the circuit boards 12, as shown in FIG. 4A.

As stated above, each strip antenna 13 has a respective operating band. When one strip antenna 13 is receiving a signal, it transmits the signal through the feed-in terminal 131 to the associating circuit board 12, enabling the associating circuit board 12 to transmit the signal to the motherboard in the notebook computer 2 through its bus line 122.

The strip antennas 13 are embedded in the front edge 111 of the holder frame 11 by means of an insert molding technique. As indicated, the antenna holder frame assembly 1 is mounted on the top side of the display screen 3 of the notebook computer 2 to hold the strip antennas 13 on the inside, saving installation space, and therefore the size of the notebook computer 2 can be minimized.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An antenna holder frame assembly comprising:
a holder frame mounted on a top side of a display screen of a notebook computer, said holder frame being a narrow elongated frame member having a front edge;
a plurality of circuit boards fixedly mounted in said holder frame, each said circuit board comprising a signal bus line electrically connected to a motherboard in said notebook computer and a ground plane; and
a plurality of strip antennas embedded in said front edge of said holder frame, each said strip antenna comprising a respective operating band and a feed-in terminal, the feed-in terminals of said circuit board being respectively electrically connected to said circuit boards.

2. The antenna holder frame assembly as claimed in claim 1, wherein said strip antennas are embedded in said holder frame by an insert molding technique.

3. The antenna holder frame assembly as claimed in claim 1, wherein said holder frame comprises a plurality of transverse partition ribs, said transverse ribs dividing said holder frame into a plurality of accommodation spaces that accommodate said circuit boards respectively.
